(19) United States
(12) Patent Application Publication
(10) Pub. No.: US 2011/0172364 A1
(43) Pub. Date: Jul. 14, 2011

(54) Charged Nanoparticles And Method Of Controlling Charge

(76) Inventors: Chen Yaohong, Akron, OH (US); Masahiro Homma, Tokyo (JP); Hideki Kitano, Tokyo (JP)

(21) Appl. No.: 12/979,732

(22) Filed: Dec. 28, 2010

Related U.S. Application Data
(60) Provisional application No. 61/290,738, filed on Dec. 29, 2009.

(51) Int. Cl. C08F 293/00; C08F 8/14; C08F 8/30; C08F 8/42; C08F 257/02; C08L 53/02

(52) U.S. Cl. 525/99; 525/386; 525/279; 525/102; 525/340; 525/354; 525/378; 525/333.3

(57) ABSTRACT

A core-first method is provided for making a core-shell nanoparticle that includes the following steps: adding to a solvent, a mono-vinyl monomer cross-linked with a cross-linking agent to form the core of the nanoparticle, the core having an average diameter of 5 nanometers to about 10,000 nanometers, and the core having polymer chains with living ends; adding a charge agent comprising a fixed formal charge group onto the living ends of the core to form the shell of the nanoparticle; controlling the charge of the nanoparticle based on the type of charge agent, the quantity of the charge agent, or both the type of charge agent and the quantity of the charge agent. A core-shell nanoparticle is also provided.

### CROSS-REFERENCE TO RELATED APPLICATION

This application claims the benefit of priority from U.S. Provisional Application No. 61/290,738, filed on Dec. 29, 2009. That prior application, including the entire written description and drawing figures, is hereby incorporated into the present application by reference.

### FIELD

The technology disclosed herein is generally related to nanoparticles. This disclosure also provides a method of making the charged nanoparticles.

### BACKGROUND AND SUMMARY

Polymer nanoparticles have attracted increased attention over the past several years in a variety of fields including catalysis, combinatorial chemistry, protein supports, magnets, and photonic crystals. Nanoparticles have been used in rubber compositions to improve physical properties of rubber moldability and tenacity. In some instances, the inclusion of polymer compositions with certain functional groups or heteroatomic monomers can produce beneficial and unexpected improvements in rubber compositions.

Charged nanoparticles may have a number of possible applications, such as in electronic devices, or in rubber or other polymer matrices. In some electronic display applications, such as QR-LPD, charged particles may be used to present a pictorial or textual display. Charged particles used in such displays suffer from physical and charge degradation due to the frictional forces imparted when the particles shift locations with oppositely charged particles. It is a challenge to provide particles that have a durable constitution and a stable charge. A method for reliably controlling and varying the charge of such particles is also needed.

Herein, a core-first method is provided for making a core-shell nanoparticle that includes the following steps: adding to a solvent, a mono-vinyl monomer cross-linked with a cross-linking agent to form the core of the nanoparticle, the core having an average diameter of 5 nanometers to about 10,000 nanometers, and the core having polymer chains with living ends; adding a charge agent comprising a fixed formal charge group onto the living ends of the core to form the shell of the nanoparticle; controlling the charge of the nanoparticle based on the type of charge agent, the quantity of the charge agent, or both the type of charge agent and the quantity of the charge agent.

Furthermore, a charged core-shell nanoparticle is also provided. The charged core-shell nanoparticle includes a core formed from a polymeric seed that includes a mono-vinyl core species cross-linked with a cross-linking agent. The core has an average diameter of 5 nanometers to about 10,000 nanometers. The shell includes a species with a formal charge group, wherein either the formal charge groups are selected from the group consisting of quaternary ammonium, quaternary phosphonium, quaternary sulfonium; or the species is selected from pyridine silane, succinic anhydride, vinyl pyridine, N,N-dimethylaminostyrene, and N,N-diethylaminostyrene and derivates thereof.

In another embodiment, a charged core-shell nanoparticle has a core formed from a polymeric seed that includes a mono-vinyl core species cross-linked with a cross-linking agent. The core has an average diameter of 5 nanometers to about 10,000 nanometers. The shell includes a species with a formal charge group. The core and the shell comprise di-block polymers extending from the core to the shell, and the di-block polymers have a core block and a shell block. The monomer contributed units of the core block include the mono-vinyl core species, and the monomer contributed units of the shell block include the species with the formal charge group.

Herein throughout, unless specifically stated otherwise: “vinyl-substituted aromatic hydrocarbon” and “alkenylbenzene” are used interchangeably; and “rubber” refers to rubber compounds, including natural rubber, and synthetic elastomers including styrene-butadiene rubber and ethylene propylene rubber, which are known in the art. Furthermore, the terms “a” and “the,” as used herein, mean “one or more.”

### BRIEF DESCRIPTION OF THE DRAWINGS

FIG. 1 is an SEM image of a collection of nanoparticles according to Example 1.

FIG. 2 is an SEM image of a collection of nanoparticles according to Example 2.

FIG. 3 is an SEM image of a collection of nanoparticles according to Example 3.

FIG. 4 is an SEM image of a collection of nanoparticles according to Example 4.

FIG. 5 is an SEM image of a collection of nanoparticles according to Example 5.

FIG. 6 is an SEM image of a collection of nanoparticles according to Example 6.

FIG. 7 is an SEM image of a collection of nanoparticles according to Example 7.

### DETAILED DESCRIPTION

A method for controlling the charge on nanoparticles and charged nanoparticles are disclosed herein. This method provides for forming a crosslinked nanoparticle core by dispersion polymerization. The core is formed of cross-linked polymers that have living ends at the surface of the core. A charge agent is then added to the living ends of the core to provide the particle with a desired charge. The species of the charge agent controls the charge on the nanoparticle. In addition, more precise charge control is achieved by adding a charged monomer along with initiator. A chain of charged monomer-contributed units thereby propagates from the living ends of the nanoparticle. The amount of charged monomer controls the overall charge of the nanoparticle.

Such charged nanoparticles may have various uses, including use as child particles in electronic displays such as electronic paper displays that use QR-LPD technology. Further details on QR-LPD and particles used therein are disclosed in U.S. Published Applications 2008/0174854 and 2006/0087718, and U.S. Pat. No. 7,236,291, which are incorporated herein by reference. A durable particle with a stable charge is especially desirable in QR-LPD displays where particles are subjected to significant frictional forces that tend to damage the structure and charge characteristics of the particles.

According to an embodiment of the method, the nanoparticle is formed by a core-first living dispersion polymerization method. Living anionic dispersion polymerization or living free radical dispersion polymerization may be used. Living anionic dispersion polymerization may be favorable over free radical dispersion polymerization for some applications. The living dispersion polymerization methods described herein are superior to emulsion synthesis methods for many applications. The nanoparticles synthesized by the methods described herein differ from star polymers in that they have a larger and decentralized core.

In dispersion polymerization, the reaction is effected by polymerizing a monomer in an organic liquid in which the resulting polymer is insoluble, using a steric stabilizer to stabilize the resulting particles of insoluble polymer in the organic liquid. Dispersion polymerization is used to prevent the propagating polymeric core from precipitating out of solution. This technique allows for a sizeable core to be formed in a range of 5 nanometers up to about 10,000 nanometers while remaining in solution. Consequently, a wide range of solvents may be used in which the polymeric core would be otherwise insoluble.

In a generalized embodiment of the core-formation step of the method, a reactor is provided with a hydrocarbon solvent, into which a mono-vinyl monomer species and a steric stabilizer are added. A polymerization initiator is added to the reactor along with a crosslinking agent. The cross-linking agent and initiator may be added in one charge to the reactor. Addition of crosslinking agent at this stage produces a well-crosslinked core; however, crosslinking agent may alternatively be added after the shell species is added. A randomizing agent may also be added to the reactor.

As the reaction proceeds, the mono-vinyl monomer is polymerized and cross-linked with the cross-linking agent. The mono-vinyl polymer chains are tied together by the cross-linking agent in a dense, stable core, wherein the mono-vinyl polymer chains have living ends at the surface of the core. The living ends are at the surface of the core due to their higher affinity to the solvent than the mono-vinyl species. The surface of the core is stabilized by a steric stabilizer such as polystyrene-polybutadiene diblock copolymer. The stabilizer is adsorbed on the surface of the core.

The highly cross-linked core enhances the uniformity, durability, and permanence of shape and size of the resultant nanoparticle. The example method may be performed in a single batch, and there is no requirement to isolate and dry the core before grafting the shell.

Specific examples of mono-vinyl monomer species include mono-vinyl aromatic species, such as styrene, α-methylstyrene, 1-vinyl naphthalene, 2-vinyl naphthalene, 1-α-methyl vinyl naphthalene, 2-α-methyl vinyl naphthalene, vinyl toluene, methoxystyrene, t-butoxystyrene, as well as alkyl, cycloalkyl, aryl, alkaryl, and aralkyl derivatives thereof, in which the total number of carbon atoms in the combined hydrocarbon is not greater than 18, as well as any di- or tri-vinyl substituted aromatic hydrocarbons, and mixtures thereof. Further examples of mono-vinyl monomer species include non-aromatic mono-vinyl monomer species, such as vinyl acetate, vinyl-methacrylate, and vinyl-alcohols.

Crosslinking agents that are at least bifunctional, wherein the two functional groups are capable of reacting with the mono-vinyl species of the core are acceptable. Examples of suitable cross-linking agents include multiple-vinyl aromatic monomers in general. Specific examples of cross-linking agents include di- or tri-vinyl-substituted aromatic hydrocarbons, such as diisopropenylbenzene, divinylbenzene, divinyl ether, divinyl sulphone, diallyl phthalate, triallyl cyanurate, triallyl isocyanurate, 1,2-polybutadiene, N,N′-m-phenylenedimaleimide, N,N′-(4-methyl-m-phenylene)dimaleimide, triallyl trimellitate acrylates, methacrylates of polyhydric C₂-C₁₀ alcohols, acrylates and methacrylates of polyethylene glycol having from 2 to 20 oxyethylene units, polyesters composed of aliphatic di- and/or polyols, or maleic acid, fumaric acid, and itaconic acid. Multiple-vinyl aromatics, such as divinylbenzene provides excellent properties and are compatible with common hydrocarbon solvents.

Specific examples of suitable steric stabilizers include styrene-butadiene diblock copolymer, polystyrene-b-polyisoprene, and polystyrene-b-polydimethylsiloxane.

As mentioned above, the dispersion polymerization technique allows for a variety of solvents. Polar solvents, including water, and non-polar solvents may be used; however, hydrocarbon solvents are beneficial for some applications. A combination of polar and non-polar solvents are also beneficial for some applications. Specific examples of solvents include aliphatic hydrocarbons, such as pentane, hexane, heptane, octane, nonane, and decane, as well as alicyclic hydrocarbons, such as cyclohexane, methyl cyclopentane, cyclooctane, cyclopentane, cycloheptane, cyclononane, and cyclodecane. These hydrocarbons may be used individually or in combination. Selection of a solvent in which one monomer forming the nanoparticles is more soluble than another monomer forming the nanoparticles is preferred for some applications.

A 1,2-microstructure controlling agent or randomizing modifier is optionally used to control the 1,2-microstructure in the mono-vinyl monomer units of the core. Suitable modifiers include 2,2-bis(2′-tetrahydrofuryl)propane, hexamethylphosphoric acid triamide, N,N,N′,N′-tetramethylethylene diamine, ethylene glycol dimethyl ether, diethylene glycol dimethyl ether, triethylene glycol dimethyl ether, tetraethylene glycol dimethyl ether, tetrahydrofuran, 1,4-diazabicyclo [2.2.2] octane, diethyl ether, triethylamine, tri-n-butylamine, tri-n-butylphosphine, p-dioxane, 1,2-dimethoxy ethane, dimethyl ether, methyl ethyl ether, ethyl propyl ether, di-n-propyl ether, di-n-octyl ether, anisole, dibenzyl ether, diphenyl ether, dimethylethylamine, bis-oxalanyl propane, tri-n-propyl amine, trimethyl amine, triethyl amine, N,N-dimethyl aniline, N-ethylpiperidine, N-methyl-N-ethyl aniline, N-methylmorpholine, tetramethylenediamine, oligomeric oxolanyl propanes (OOPs), 2,2-bis-(4-methyl dioxane), and bistetrahydrofuryl propane. A mixture of one or more randomizing modifiers also can be used. The ratio of the modifier to the monomers can vary from a minimum as low as 0 to a maximum as great as about 4000 millimoles, for example about 0.01 to about 3000 millimoles, of modifier per hundred grams of monomer currently being charged into the reactor. As the modifier charge increases, the percentage of 1,2-microstructure (vinyl content) increases in the conjugated diene contributed monomer units in the surface layer of the polymer nanoparticle. The 1,2-microstructure content of the conjugated diene units is for example, within a range of about 5% and about 95%, such as less than about 35%.

Suitable initiators for the core formation process include anionic initiators that are known in the art as useful in the polymerization of mono and multiple-vinyl monomers. Exemplary organo-lithium initiators include lithium compounds having the formula R(Li)ₓ, wherein R represents a C₁-C₂₀ hydrocarbyl radical, such as a C₂-C₈ hydrocarbyl radical, and x is an integer from 1 to 4. Typical R groups include aliphatic radicals and cycloaliphatic radicals. Specific examples of R groups include primary, secondary, and tertiary groups, such as n-propyl, isopropyl, n-butyl, isobutyl, and t-butyl.

Specific examples of initiators include ethyllithium, propyllithium, n-butyllithium, sec-butyllithium, and tert-butyllithium; aryllithiums, such as phenyllithium and tolyllithium; alkenyllithiums such as vinyllithium, propenyllithium; alkylene lithium such as tetramethylene lithium, and pentamethylene lithium. Among these, n-butyllithium, sec-butyllithium, tert-butyllithium, tetramethylene lithium, and mixtures thereof are specific examples. Other suitable lithium initiators include one or more of: p-tolyllithium, 4-phenylbutyl lithium, 4-butylcyclohexyl lithium, 4-cyclohexylbutyl lithium, lithium dialkyl amines, lithium dialkyl phosphines, lithium alkyl aryl phosphine, and lithium diaryl phosphines.

Free radical initiators may also be used in conjunction with a free radical polymerization process. Examples of free-radical initiators include: 2,2′-azo-bis(isobutyronitril, 1,1′-azobis(cyclohexanecarbonitrile), 2,2′-azobis(2-methylpropionamidine) dihydrochloride, 2,2′-azobis(2-methylpropionitrile), 4,4′-azobis(4-cyanovaleric acid), 1,1-bis(tert-amylperoxy)cyclohexane, 1,1-bis(tert-butylperoxy)-3,3,5-trimethylcyclohexane, 1,1-bis(tert-butylperoxy)cyclohexane, 2,2-bis(tert-butylperoxy)butane, 2,4-pentanedione peroxide, 2,5-bis(tert-butylperoxy)-2,5-dimethylhexane, 2,5-bis(tert-butylperoxy)-2,5-dimethylhexane, 2-butanone peroxide, 2-butanone peroxide, 2-butanone peroxide, benzoyl peroxide, cumene hydroperoxide, di-tert-amyl peroxide, dicumyl peroxide, lauroyl peroxide, tert-butyl hydroperoxide, ammonium persulfate, hydroxymethanesulfinic acid monosodium salt dehydrate, potassium persulfate, and reagent grade sodium persulfate.

Functionalized lithium initiators are also contemplated as useful in the polymerization of the core species. A functionalized initiator serves to functionalize the core, and the functional groups are likely distributed throughout the surface and interior of the core. Example functional groups include amines, formyl, carboxylic acids, alcohols, tin, silica, and mixtures thereof.

Amine-functionalized initiators include those that are the reaction product of an amine, an organo lithium, and a solubilizing component. The initiator has the general formula:

(A)Li(SOL)_{y}

where y is from 1 to 3; SOL is a solubilizing component selected from the group consisting of hydrocarbons, ethers, amines or mixtures thereof; and, A is selected from the group consisting of alkyl, dialkyl and cycloalkyl amine radicals having the general formula:

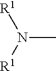

and cyclic amines having the general formula:

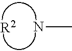

where R¹ is selected from the group consisting of alkyls, cycloalkyls or aralkyls having from 1 to 12 carbon atoms, and R² is selected from the group consisting of an alkylene, substituted alkylene, oxy- or N-alkylamino-alkylene group having from 3 to 16 methylene groups. A specific example of a functionalized lithium initiator is hexamethylene imine propyllithium.

Tin functionalized lithium initiators may also be useful in synthesizing the nanoparticles. Suitable tin functionalized lithium initiators include tributyl tin lithium, trioctyl tin lithium, and mixtures thereof.

Anionic initiators generally are useful in amounts ranging from about 0.01 to about 60 millimoles per hundred grams of monomer charge. Free radical initiators are useful in amounts ranging from about 6 to about 100 millimoles per hundred grams of monomer charge.

The core may range in size from 5 nanometers to about 10,000 nanometers, for example about 25 to about 1,000 nanometers, about 40 to about 150 nanometers, about 50 to about 125 nanometers, or about 100 to about 1,000 nanometers. The core differs from that of a star polymer in that it does not emanate from a single point, but instead is decentralized and has a minimum size of 5 nanometers.

The shell of the nanoparticles is formed by grafting a shell species onto the living ends of the cross-linked core or terminating the living ends. The nanoparticle is thus formed with polymers, copolymers, or the terminating agent of the core polymers extending from the cross-linked core into the shell. The shell species or the terminator may include a charge agent that provides a charge to the nanoparticles, and the nature and quantity of such shell species or terminator allows control of the charge on the nanoparticle.

One method of adding a charge agent to the living ends of the nanoparticle core is through the addition of a functionalized terminator. The functionalized terminator includes a charge agent that has a fixed formal charge group that exists after the addition to the nanoparticle. By fixed formal charge it is meant a charge that results from an actual excess or deficiency of electrons, not merely a localized charge due to an electron rich area of the molecule.

Once the core is formed and a desired yield is obtained, the functional terminator containing the charge agent is added to the reactor. In an embodiment, this is a one-pot process that does not require a separate isolation step or drying step to isolate and dry the core.

The added terminator terminates the living ends of the mono-vinyl polymer chains of the core and places a functional group containing the charge agent on the end of the chains. In this embodiment the functional group is considered to be the shell layer of the nanoparticle. The very thin functional group shell layer has the advantage of being physically durable and resistant to frictional shearing forces. This is due to its short length and proximity to the highly crosslinked core of the nanoparticle.

By selecting a charge agent that has a known charge, one can craft a nanoparticle with a desired charge that is physically durable and resistant to frictional shearing forces. The charge agent may be selected from a variety of charge agents that have a fixed formal charge. For most applications, species with a more stable, fixed, formal charge are preferred. Examples of compounds that may have a stable, fixed, formal charge include nitrogen- and oxygen-containing species, such as cyclic compounds, including without limitation, succinic anhydride, imidazole, pyridines, N,N-dimethylaminostyrene and N,N-diethylaminostyrene, including without limitation, pyridine silane or vinyl pyridine and the derivates of all the above. Nitrogen containing species that contain quaternary ammonium compounds have a particularly stable charge. Quaternary phosphonium and quaternary sulfonium compounds are similar species with stable charges. Nitrogen-containing species, such as pyridines may readily be imparted with a positive formal charge, whereas oxygen-containing species, such as succinic anhydride, may readily be imparted with a negative formal charge.

A second, more versatile, method of adding a charge agent to the living ends includes polymerizing one or more monomer units having a charge agent with a fixed formal charge onto the living ends of the nanoparticle core. Once the core is formed from the core formation process discussed above and a desired yield is obtained, a monomer that includes the charge agent may be added to the reactor along with a polymerization initiator. Again, this is a one-pot process that does not require separate isolation or drying of the core. The monomer containing the charge agent bonds to the living ends of the mono-vinyl polymer chains of the core. Depending on reaction conditions, and the amount of monomer and initiator, additional monomer-contributed units will propagate in polymer chains originating from the living ends of the mono-vinyl polymer chains of the nanoparticle core. In this way, the nanoparticle comprises diblock polymer chains with a mono-vinyl block that is crosslinked and a charge agent block. The charge agent block may be considered to be the shell layer of the nanoparticle, while the cross-linked mono-vinyl block may be considered to be the core layer of the nanoparticle. Similarly, the shell block of the diblock polymers that comprise the nanoparticle include the charge agent monomers as monomer contributed units, while the core block includes the mono-vinyl monomers as monomer contributed units.

In another method of adding a charge agent to the living ends of the nanoparticle core, the charge agent is a monomeric species that has already been polymerized in a separate reactor and then added to the reactor that holds the core with living ends. An addition of the preformed polymeric charge agent to the reactor containing the core would result in the polymer chains being grafted to the cross-linked core, thereby forming a shell with propagated charge agent chains.

In another method of adding a charge agent to the living ends of the nanoparticle core, a charge agent monomer is added to the reactor. The monomer may be a hydrocarbon containing one or more heteroatoms, and it may be functionalized. The monomer is added with no initiator and grafts onto the living ends of the core. This method forms a nanoparticle with a shell having a single charge agent layer.

The charge of the nanoparticle can be controlled by the selection of the charge agent, and it can also be controlled by the number of charge agents present in the nanoparticle. The number of charge agents in the nanoparticle is a function of the amount of charge-agent-containing monomer and the length of the charge agent block of the polymer chains. It is also a function of the number of living ends present on the surface of the core (onto which the charge agent-containing-monomer attaches).

The nanoparticle core will have a negative charge due to the electron-rich localized charge induced by the mono-vinyl monomer contributed units and the cross-linking agent. Addition and polymerization of a shell monomer with a positive charge agent such as pyridine will cause the overall charge of the nanoparticle to be less negative, and continued addition and polymerization of the monomer will cause the charge on the nanoparticle to become positive. Conversely, addition and polymerization of a shell monomer with a negative charge agent such as succinic anhydride will cause the overall charge of the nanoparticle to be more negative. Thus, in general, the more charge agent monomer-contributed units that are present in the shell layer of the nanoparticle, and the longer each charge agent block polymer chain is, the more positive or negative the charge on the nanoparticle will become according to whether a positive or negative charge agent is used. In this manner one can select a charge agent and polymerize additional monomer units until a desired charge is reached.

A wide range of equilibrium weight-average charge values can be reached by this method. For example, the charge may range from about −500 μC/g to about 600 μC/g, such as about −300 μC/g to about 300 μC/g, or about −150 μC/g to about 150 μC/g. Negatively charged nanoparticles may, for example, have charges of about −10 μC/g or less, such as about −50 μC/g or less, about −500 μC/g to about −50 μC/g, or about −150 μC/g to about −50 μC/g. Positively charged nanoparticles may have charges of greater than about 0 μC/g, such as about 50 μC/g or greater, about 1 to about 600 μC/g, about 100 to about 300 μC/g, or about 300 to about 600 μC/g. The amount (Q) of the charged nanoparticles, may range from about 1 to about 600 μC/g, such as about 1 to about 100 μC/g, or

The core-first nanoparticle formation process allows the nanoparticle to include charge agent species in the shell. Because the shell is formed last, the shell species does not need to be as stable as it would if it were formed first and had to survive the core formation and cross-linking process. Thus, the core-first process can produce many new nanoparticles that were difficult or impossible to make with shell first processes.

While having long, uncrosslinked polymer chains in the shell may be beneficial in some applications, to preserve the charge and the durability of the nanoparticle, relatively short shell layer chain lengths are preferable for some applications. The longer the shell layer chain lengths become, the more susceptible they are to frictional shear forces and degradation. Accordingly, a relatively thin shell layer is preferable for some applications, such as for electronic displays. For example, the shell layer may be about 1 nm to about 100 nm, such as about 1 nm to about 50 nm, or about 1 nm to about 25 nm.

For certain applications such as QR-LPD display technologies, making both positively and negatively charged nanoparticles to be used in cells together is required. The methods and nanoparticles described herein are particularly well suited to controlling the polarity and the magnitude of a group of positive and negative particles. In an embodiment, a first group of nanoparticles and a second group of nanoparticles may have a difference in charge of about 50 μC/g or greater, such as about 50 to about 500 μC/g, or about 75 to about 200 μC/g.

Functional terminators for use with the shell species include SnCl₄, R₃SnCl, R₂SnCl₂, RSnCl₃, carbodiimides, N-methylpyrrolidine, cyclic amides, cyclic ureas, isocyanates, Schiff bases, 4,4′-bis(diethylamino) benzophenone, N,N′-dimethylethyleneurea, and mixtures thereof, wherein R is selected from the group consisting of alkyls having from 1 to 20 carbon atoms, cycloalkyls having from 3 to 20 carbon atoms, aryls having from 6 to 20 carbon atoms, aralkyls having from 7 to 20 carbon atoms, and mixtures thereof.

The size of the entire core-shell charged nanoparticles, including both core and shell—expressed as a mean average diameter—are, for example, between about 5 and about 20,000 nanometers, such as about 50 to about 5,000 nanometers, about 100 to about 200 nanometers, or about 75 to about 150 nanometers.

For some applications the nanoparticles are preferably substantially monodisperse and uniform in shape. The dispersity is represented by the ratio of M_{w} to Mₙ, with a ratio of about 1 being substantially monodisperse. The nanoparticles may, for example, have a dispersity less than about 1.3, such as less than about 1.2, or less than about 1.1. Moreover, the nanoparticles may be spherical, though shape defects are acceptable for some applications, provided the nanoparticles generally retain their discrete nature with little or no polymerization between particles.

With respect to the monomers and solvents identified herein, nanoparticles are formed by maintaining a temperature that is favorable to polymerization of the selected monomers in the selected solvent(s). Reaction temperatures are, for example, in the range of about −40 to about 250° C., such as a temperature in the range of about 0 to about 150° C.

In an embodiment the nanoparticles are substantially discrete. For example, the nanoparticles may have less than about 20% cross-linking between nanoparticles, such as less than about 15% or less than about 10% cross-linking between nanoparticles.

The number average molecular weight (Mn) of the entire nanoparticle may be controlled within the range of from about 10,000 to about 200,000,000, within the range of from about 50,000 to about 1,000,000, or within the range of from about 100,000 to about 500,000. The polydispersity (the ratio of the weight average molecular weight to the number average molecular weight) of the polymer nanoparticle may be controlled within the range of from 1 to about 2.0, within the range of from 1 to about 1.5, or within the range of from 1 to about 1.2. The Mn may be determined by using thermal field flow fractionation (TFF).

In one embodiment, the core of the synthesized nanoparticles is densely cross-linked and hard. This property is expressed as the core having a Tg of 150° C. or higher. In another embodiment, the nanoparticles have a core that is relatively harder than the shell, for example, at least 60° C. higher than the Tg of the shell layer, or in another embodiment at least 10° C. higher than the Tg of the shell layer.

In another embodiment, the shell layer is also relatively hard. For example, the shell may also have a Tg of about 100° C. or greater, such as about 150° C. or higher. A hard shell is facilitated in one embodiment by a very short chain length in the shell layer, such as in the terminated core embodiment. The thermodynamic stability of the core transfers to the shell and imparts a rigid characteristic that results in a high Tg.

The Tg of the polymers in the nanoparticles can be controlled by the selection of monomers and their molecular weight, styrene content, and vinyl content. It is also controlled by the amount of cross-linking agent used and the degree of crosslinking. The Tg of the shell may be controlled by its diameter and proximity to the heavily cross-linked core.

In an embodiment, the nanoparticles are hydrophobic. This provides resistance to moisture and its disruptive effects on charge and molecular structure. In an embodiment, the core is hydrophobic and/or the shell are hydrophobic.

The present nanoparticles and methods now will be described with reference to non-limiting working examples. The following examples and tables are presented for purposes of illustration only and are not to be construed in a limiting sense.

### EXAMPLES

A 0.8 liter nitrogen-purged glass bottle sealed with a septum liner and perforated crown cap was used as the reactor vessel for the examples below. Styrene (33 wt % in hexane), hexane, n-butyllithium (1.60 M in hexane), 2,2-bis(2′-tetrahydrofuryl)propane (1.60 M in hexane, stored over calcium hydride) and BHT solution in hexane were also used. PS-PB diblocks STEREON S730AC and STEREON 5721 were obtained from Firestone Polymers. Commercially available reagents, N,N,N′,N′-tetramethylenediamine (TMEDA), hexanemethylphosphoric acid triamide (HMPA) and 4-[2-(trichlorosilyl)ethyl-pyridine, were obtained from Aldrich and Gelest Inc. (Morrisville, Pa.) and dried over molecular sieves (3 Å).

### Example 1

To a 0.8 liter nitrogen-purged glass bottle was added 65 g of hexane, 74 g of 33 wt % styrene, 1 ml DVB, 5 ml of 5 wt % STEREON S730AC, and 0.4 ml of 1.4 M sec-butyl lithium. After stirring one day at room temperature, 1.5 ml of 13% 4-[2-(trichlorosilyl)ethyl-pyridine was added to the bottle and stirred overnight. The products were coagulated with isopropyl alcohol and dried in vacuum.

### Example 2

To a 0.8 liter nitrogen-purged glass bottle was added 65 g of hexane, 74 g of 33 wt % styrene, 1 ml of DVB, 5 ml of 5 wt % STEREON S730AC, and 0.4 ml of 1.4 M sec-butyl lithium. After stirring one day at room temperature, 10 ml of 0.1M succinic anhydride was added to the bottle and stirred for two days. The products were coagulated with isopropyl alcohol and dried in vacuum.

### Example 3

To a 0.8 liter nitrogen-purged glass bottle was added 300 g of hexane, 20 g of 33 wt % styrene, 30 ml of THF, 1 ml of DVB (50% in hexane), 10 ml of 5 wt % STEREON S730AC, and 0.5 ml of 1.6 M butyl lithium. After addition of 9 ml DVB (50%), 4 ml of 1 M HMPA was added to the bottle. The reaction mixture was stirred for 4 days at room temperature. The product was coagulated with isopropyl alcohol, filtered, and dried in vacuum.

### Example 4

To a 0.8 liter nitrogen-purged glass bottle was added 300 g of hexane, 20 g of 33 wt % styrene, 30 ml of THF, 1 ml of DVB (50% in hexane), 10 ml of 5 wt % STEREON S730AC, and 0.5 ml of 1.6 M butyl lithium. After addition of 9 ml DVB (50%), 4 ml of 1 M HMPA was added to the bottle. The reaction mixture was stirred for 4 days at room temperature. After cooling 100 ml of the cement at −78° C. with MeOH/dry ice bath, 1 ml of 2-vinyl-pyridine was added to the bottle and stirred for two days at −78° C. The products were terminated with MeOH, filtered, and dried in vacuum.

### Example 5

To a 0.8 liter nitrogen-purged glass bottle was added 300 g of hexane, 20 g of 33 wt % styrene, 30 ml of THF, 1 ml of DVB (50% in hexane), 10 ml of 5 wt % STEREON S730AC, and 0.5 ml of 1.6 M butyl lithium. After addition of 9 ml of DVB (50%), 4 ml of 1 M TMEDA was added to the bottle. The reaction mixture was stirred for 4 days at room temperature and formed a cement. After cooling 100 ml of the cement at −78° C. with MeOH/dry ice bath, 1 ml 2-vinyl-pyridine was added to the bottle and stirred for two days at −78° C. The product was terminated with MeOH, filtered, and dried in vacuum.

### Example 6

To a 0.8 liter nitrogen-purged glass bottle was added 300 g hexane, 30 ml of THF, 20 g of 33 wt % styrene, 0.4 ml of DVB, 1 ml of 5 wt % STEREON 5721, and 0.5 ml of 1.6 M butyl lithium of 0° C. The system was gradually let back to room temperature, while 0.4 ml of DVB was incrementally added to the bottle respectively at 2, 5, 10 and 20 min, and then 1 ml DVB was incrementally added at 1, 3, 5 and 24 h. The reaction mixture was stirred for three days at room temperature. After cooling with MeOH/dry ice bath at −78° C., 2 ml of 2-vinyl-pyridine was added to the bottle, which contained about 400 ml of the polymer cement, and stirred for two days at −78° C. The products were terminated with MeOH, filtered, and dried in vacuum.

### Example 7

To a 0.8 liter nitrogen-purged glass bottle was added 300 g of hexane, 30 ml THF, 20 g of 33 wt % styrene, 0.4 ml of DVB, 1 ml of 5 wt % STEREON 5721, 0.3 ml of 1 M TMEDA and 0.5 ml of 1.6 M butyl lithium at 0° C. The system was gradually back to room temperature while 0.4 ml DVB was incrementally added to the bottle at 2, 5, 10 and 20 min, and then 1 ml DVB was incrementally added at 1, 3, 5 and 24 h. The reaction mixture was stirred for three days at room temperature. After cooling with MeOH/dry ice bath at −78° C., 2 ml of 2-vinyl-pyridine was added to the bottle, which contained about 400 ml of the polymer cement, and stirred for two days at −78° C. The products were terminated with MeOH, filtered and dried in vacuum.

Examples 1-7 produced polymeric nanoparticles by living anionic dispersion polymerization that were charged with various charge agents (CA) through a termination or sequential copolymerization. The charge characteristics of the nanoparticles were characterized with triboelectric measurement by the blow-off method at 1000 shaking times. In the blow-off method, a mixture of nanoparticle powder and carrier is placed into a cylindrical container with nets at both ends, and high pressure gas is blown from one end to separate the powder and the carrier. Only the powder is blown off from the mesh of the net, and the charge of the powder is carried away out of the container. Then, all of the electric flux resulting from the charge of the powder is collected to a Faraday cage where the electric flux is charged across a capacitor. Accordingly, the charge of the particles (Q) is determined as Q=−CV (C: capacity, V: voltage across both ends of the capacitor) by measuring the potential of both ends of the capacitor.

TB-200, produced by Toshiba Chemical Co., Ltd. was used as the blow-off powder charge measuring instrument. F963-2535, available from Powder TEC Co., Ltd. was employed as the carrier, and a specific gravity of the particle substance constituting the liquid powder was measured by a multi-volume density meter H1305 produced by Shimadzu Corporation. The charge amount per weight (unit: μC/g) was calculated. The results are summarized in Tables 1 and 2.

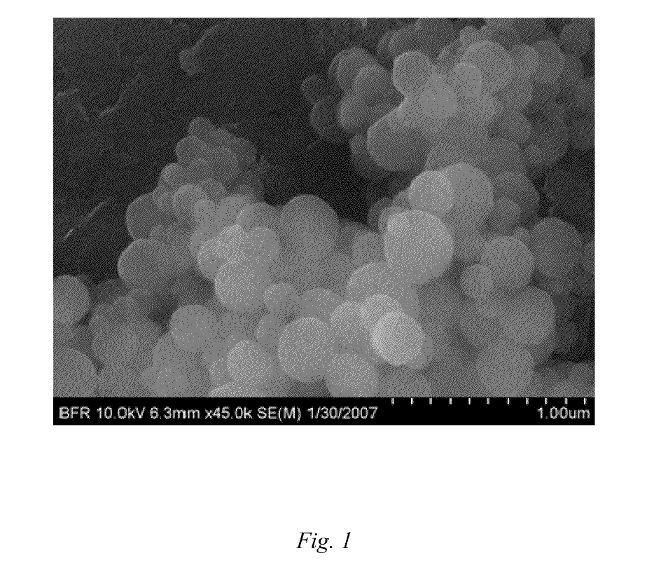

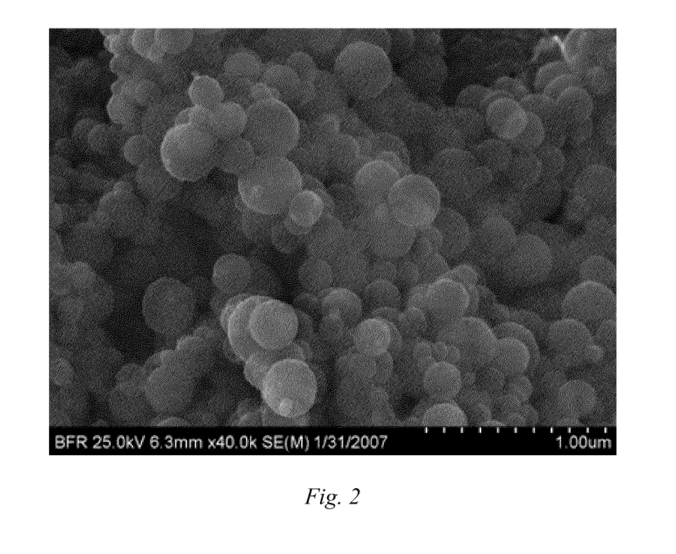

TABLE 1

| | Example 1 | Example 2 |
|---|---|---|
| St/DVB/CA | 95.4/3.6/1 | 96/3.6/0.4 |
| Modifier | OOPS | OOPS |
| CA Structure | Pyridine silane | Succinic anhydride |
| q/m [μC/g] (1k shaking time | 6.9 | −138 |
| Blow-off) | | |
| Size (nm) | 200-300 | 200-300 |
| SEM image | FIG. 1 | FIG. 2 |

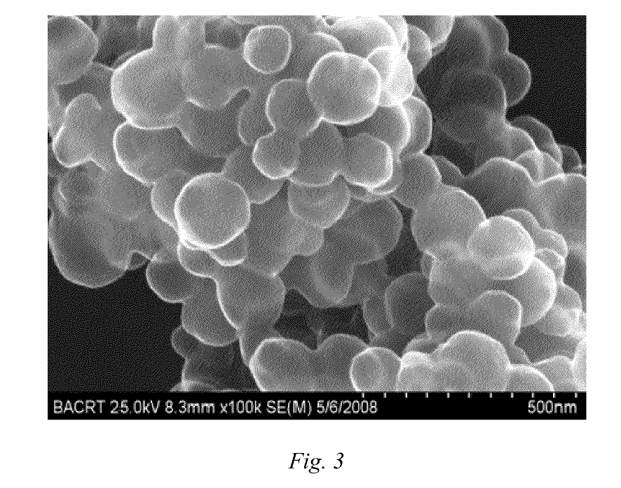

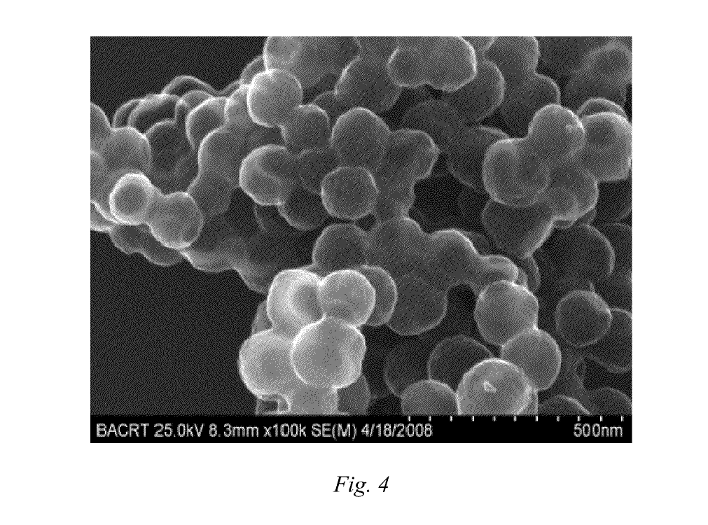

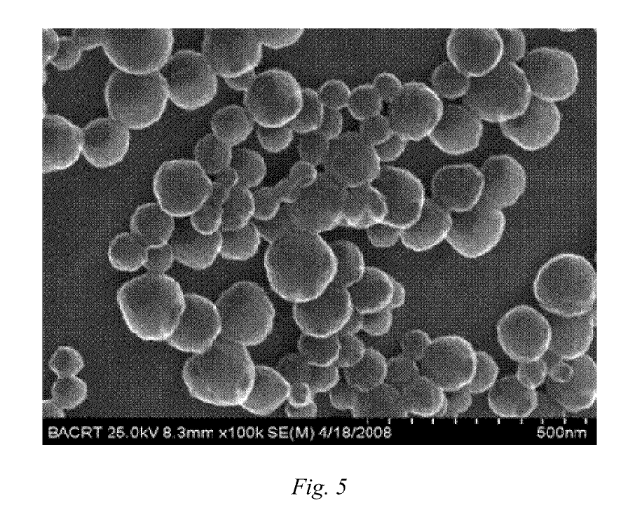

TABLE 2

| | Example 3 | Example 4 | Example 5 |
|---|---|---|---|
| St/DVB/CA (% by | 62/38/0 | 42/25/33 | 42/25/33 |
| wt.) | | | |
| Modifier | THF/HMPA | THF/HMPA | THF/TMEDA |
| CA Structure | none | 2-vinylpyridine | 2-vinylpyridine |
| q/m [μC/g] (1,000 | −45.5 | 143.7 | 86.2 |
| shaking time Blow- | | | |
| off) | | | |
| Size (nm) | 100-200 | 100-200 | 100-200 |
| SEM image | FIG. 3 | FIG. 4 | FIG. 5 |

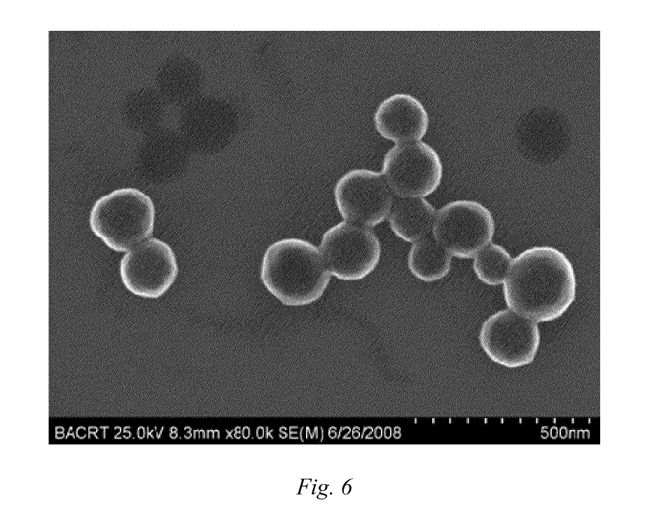

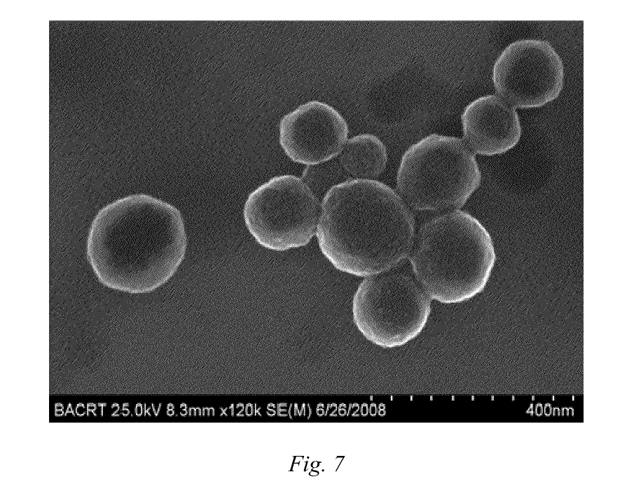

TABLE 3

| | Example 6 | Example 7 |
|---|---|---|
| St/DVB/Ca (% by wt.) | 47/39/14 | 47/39/14 |
| Modifier | THF | THF/TMEDA |
| CA Structure | 2-vinylpyridine | 2-vinylpyridine |
| q/m [μC/g] (1k shaking time | 56.3 | 76.3 |
| Blow-off) | | |
| Size (nm) | 100-200 | 100-200 |
| SEM image | FIG. 6 | FIG. 7 |

The termination with different types of charge agents (Examples 1 and 2) resulted in particles with both positive and negative charges. The styrene particle (Example 3), which did not include a charge agent, was negatively charged due to its electron rich nature. The particle charge can be turned into positive by binding pyridines on the surface through sequential copolymerization. Examples 4-7 show the effect of varying the amounts of charge agent.

This written description sets forth the best mode of the invention, and describes the invention so as to enable a person skilled in the art to make and use the invention, by presenting descriptions of various embodiments and examples. The patentable scope of the invention is defined by the claims, and may include other examples that occur to those skilled in the art.

It is claimed:

1. A core-first method for making a core-shell nanoparticle, comprising the steps of:
adding to a solvent, a mono-vinyl monomer cross-linked with a cross-linking agent to form the core of the nanoparticle, the core having an average diameter of 5 nanometers to about 10,000 nanometers, and the core having polymer chains with living ends;
adding a charge agent comprising a fixed formal charge group onto the living ends of the core to form the shell of the nanoparticle;
controlling the charge of the nanoparticle based on one of the following criteria: the type of charge agent, the quantity of the charge agent, or both the type of charge agent and the quantity of the charge agent.

2. The method of claim 1, wherein the fixed formal charge group is a nitrogen containing monomer.

3. The method of claim 1, wherein the formal charge groups are selected from the group consisting of quaternary ammonium, quaternary phosphonium and quaternary sulfonium.

4. The method of claim 1 further comprising adding a solution stabilizer.

5. The method of claim 1, wherein the stabilized seed is made by living dispersion polymerization.

6. The method of claim 1, wherein the step of adding a charge agent comprises adding a functional terminator to terminate the living ends of the core, wherein the functional terminator includes the charge agent.

7. The method of claim 1, wherein the step of adding a charge agent comprises polymerizing one or more monomer units having a fixed formal charge group onto the living ends of the core.

8. The method of claim 7, wherein the charge is controlled by polymerizing additional monomer having a fixed formal charge group onto the nanoparticle.

9. The method of claim 7, further comprising the step of adding the monomer at least until an overall charge of the nanoparticle changes from negative to positive.

10. The method of claim 7, further comprising the step of adding the monomer until an overall charge of the nanoparticle reaches a predetermined charge value.

11. The method of claim 7, further comprising the step of selecting a charge agent that will provide the nanoparticle with a predetermined charge value.

12. The method of claim 1, wherein the core has an average diameter of about 50 nanometers to about 150 nanometers.

13. The method of claim 1, wherein the cross-linking agent is a multiple-vinyl aromatic monomer.

14. The method of claim 1, with the proviso that emulsion polymerization is not used to synthesize the seed.

15. The method of claim 1, wherein the solvent comprises a hydrocarbon solvent.

16. Charged core-shell nanoparticles comprising:
a core formed from a polymeric seed that includes a mono-vinyl core species cross-linked with a cross-linking agent, the core having an average diameter of 5 nanometers to about 10,000 nanometers;
a shell comprising a species with a formal charge group, wherein either the formal charge groups are selected from the group consisting of quaternary ammonium, quaternary phosphonium, quaternary sulfonium; or the species is selected from pyridine silane, succinic anhydride, vinyl pyridine, N,N-dimethylaminostyrene, and N,N-diethylaminostyrene and derivates thereof.

17. The charged core-shell nanoparticles of claim 16, wherein a first group of charged nanoparticles has a positive charge and a second group of nanoparticles has a negative charge.

18. The charged core-shell nanoparticles of claim 16, wherein the nanoparticles have a negative charge of about −50 μC/g or less.

19. The charged core-shell nanoparticles of claim 16, wherein the nanoparticles have a charge of about 0 μC/g or greater.

20. The charged core-shell nanoparticles of claim 17, wherein the difference in charge between the first group and the second group of nanoparticles is about 50 μC/g or more.

21. The core-shell nanoparticle of claim 16, wherein the nanoparticles have an average diameter of about 50 nanometers to about 500 nanometers.

22. The core-shell nanoparticle of claim 16, wherein a Tg of the core is about 150° C. or greater.

23. The core-shell nanoparticle of claim 16, wherein the core species and the shell species are monomer-contributed units of diblock copolymers that extend from the core into the shell.

24. Charged core-shell nanoparticles comprising:
a core formed from a polymeric seed that includes a mono-vinyl core species cross-linked with a cross-linking agent, the core having an average diameter of 5 nanometers to about 10,000 nanometers;
a shell comprising a species with a formal charge group;
wherein the core and the shell comprise di-block polymers extending from the core to the shell, the di-block polymers having a core block and a shell block;
wherein monomer contributed units of the core block include the mono-vinyl core species, and monomer contributed units of the shell block include the species with the formal charge group.

25. The charged core-shell nanoparticles of claim 24, wherein the shell block comprises two or more monomer contributed units.
